(19) United States
(12) Patent Application Publication
(10) Pub. No.: US 2017/0083820 A1
(43) Pub. Date: Mar. 23, 2017

(54) POSTERIOR PROBABILISTIC MODEL FOR BUCKETING RECORDS

(71) Applicant: INTERNATIONAL BUSINESS MACHINES CORPORATION, ARMONK, NY (US)

(72) Inventors: RUO BO HUANG, BEIJING (CN); LI MEI JIAO, BEIJING (CN); SCOTT SCHUMACHER, PORTER RANCH, CA (US); CHEN WANG, BEIJING (CN)

(21) Appl. No.: 14/859,384

(22) Filed: Sep. 21, 2015

(51) Int. Cl. G06N 7/00; G06F 17/30

(52) U.S. Cl. CPC G06N 7/005; G06F 17/30345

(57) ABSTRACT

In one embodiment, a computer-implemented method includes receiving a plurality of external records from one or more data sources. A plurality of sets of top k dominant words for the plurality of external records are determined by a computer processor. The plurality of sets of top k dominant words include a set of top k dominant words for each external record of the plurality of external records, and k is an integer. A bucketing algorithm is performed on the plurality of external records while excluding from consideration words within each external record that are not within the set of top k dominant words for the external record.

### BACKGROUND

Embodiments of the present invention relate to records bucketing and, more specifically, to a posterior probabilistic model for bucketing records.

Many Not Only Structured Query Language (NoSQL) data stores have been produced in recent years, due to their good horizontal scalability, lower cost data management, and flexibility. NoSQL allows for storage and retrieval of data that need not be organized based on tabular relations used in relational databases. Some characteristics of NoSQL data stores simplify interactions between cloud applications and the data stores. One such characteristic is the use of JavaScript Object Notation (JSON), which is used by many NoSQL data stores for data representation.

However, the use of NoSQL, especially with JSON, leads to difficulties in various data management tasks. One of these management tasks is entity resolution (ER), which is the problem of identifying which of multiple records in a database refer to the same real-world entity. For example, if a patient visits multiple medical facilities, that patient's information may be entered in different ways in each facility. For instance, the patient's middle name may be entered in some facilities and not others, or the patient may use her work phone number at some facilities and her mobile phone number at others. The traditional challenges of ER are name and attribute ambiguity, errors due to data entry, and missing value. Entity resolution for JSON data differs from traditional entity resolution in various ways due to the following: sources of JSON data are highly heterogeneous in structure, with considerable variety even for a single data collection and similar entities; JSON data is dynamic, because schemas evolve continuously; and JSON data sources are of widely differing quality, with significant differences in the coverage, accuracy, and timeliness of data provided.

Generally, ER is performed in three parts: bucketing, entity matching, and records merging. Bucketing, also referred to as blocking, involves grouping entities based on similarities. After blocking takes place, it can be assumed that records in different blocks are unlikely to represent the same entity. Thus, when searching for entity matches, each record need be compared only to other records within the same bucket. Bucketing can also ensure scalability, in that regardless of how many buckets exist, only a small number of records within a single bucket need to be searched.

One technique for bucketing is meta-blocking. An entity may be described in one or more records, where each record includes a set of attributes, each having a value or being empty and thus having no value. Each value includes one or more words. In meta-blocking, each record appearing in a set of records may be represented as a node within a graph. The various words within records are compared to one another, and an edge is established between two records if those records contain a common word. Because words are being compared directly without regard to attribute names or complete values, these comparisons are schema-agnostic. The weight of each edge spanning between two nodes represented by two records is the quantity of words that are shared between those two records. A meta-blocking process may then prune edges whose weights fall below a certain threshold. Based on the complete graph, a meta-blocking technique groups the records into buckets based on the weights of the remaining edges. Entity matching record merging may then be performed.

### SUMMARY

According to an embodiment of this disclosure, a computer-implemented method includes receiving a plurality of external records from one or more data sources. A plurality of sets of top k dominant words for the plurality of external records are determined by a computer processor. The plurality of sets of top k dominant words include a set of top k dominant words for each external record of the plurality of external records, and k is an integer. A bucketing algorithm is performed on the plurality of external records while excluding from consideration words within each external record that are not within the set of top k dominant words for the external record.

In another embodiment, a system includes a memory and one or more computer processors communicatively coupled to the memory. The one or more computer processors are configured to receive a plurality of external records from one or more data sources. The one or more computer processors are further configured to determine a plurality of sets of top k dominant words for the plurality of external records. The plurality of sets of top k dominant words include a set of top k dominant words for each external record of the plurality of external records, and k is an integer. The one or more computer processors are further configured to perform a bucketing algorithm on the plurality of external records while excluding from consideration words within each external record that are not within the set of top k dominant words for the external record.

In yet another embodiment, a computer program product for bucketing records includes a computer readable storage medium having program instructions embodied therewith. The program instructions are executable by a processor to cause the processor to perform a method. The method includes receiving a plurality of external records from one or more data sources. Further according to the method, a plurality of sets of top k dominant words are determined for the plurality of external records. The plurality of sets of top k dominant words include a set of top k dominant words for each external record of the plurality of external records, and k is an integer. A bucketing algorithm is performed on the plurality of external records while excluding from consideration words within each external record that are not within the set of top k dominant words for the external record.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a bucketing system within a system for entity resolution, according to some embodiments of this disclosure;

FIG. 2 is a block diagram of the bucketing system, according to some embodiments of this disclosure;

FIG. 3 is a flow diagram of a method for bucketing records, according to some embodiments of this disclosure; and

FIG. 4 is a block diagram of a computer system for implementing some or all aspects of the bucketing system, according to some embodiments of this disclosure.

### DETAILED DESCRIPTION

Various embodiments of this disclosure are configured to bucket records from various sources in a schema-agnostic manner. This may be achieved by inputting data from an entity knowledge base and, thus, identifying dominant features of the records using posterior probabilities.

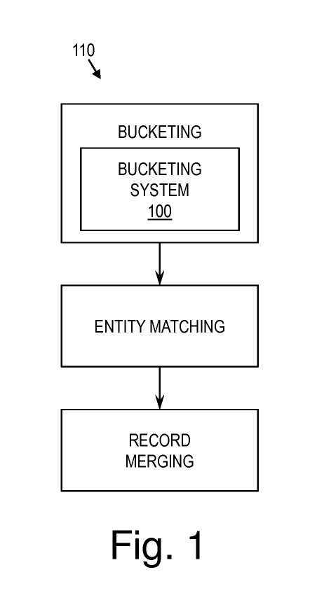

FIG. 1 is a block diagram of a bucketing system 100, within an entity resolution system 110, according to some embodiments of this disclosure. In some embodiments, the entity resolution system 110 resolves entities represented by various records. The entity resolution system 110 may perform various operations to this end, including bucketing, entity matching, and record merging. Generally, bucketing is the process of grouping records based on similarity; entity matching is the process of comparing records within each bucket to find records referring to the same entity; and record merging is the process of combining records referring to the same entity. As shown, the bucketing system 100 performs at least a portion of the bucketing operations for the entity resolution system 100. In some embodiments, the bucketing system 100 utilizes a variation of meta-blocking, as will be described further below.

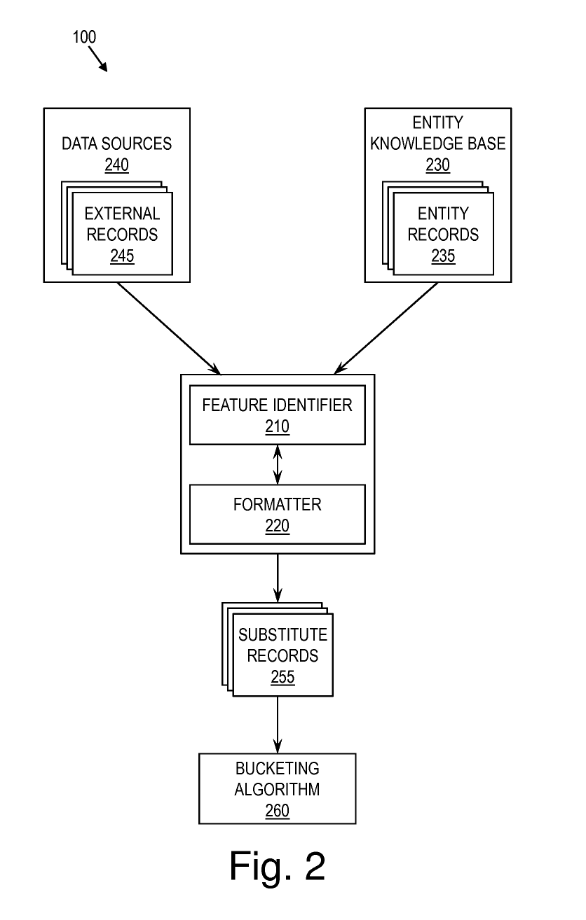

FIG. 2 is a block diagram of the bucketing system 100, according to some embodiments of this disclosure. As shown, the bucketing system 100 includes a feature identifier 210 and a formatter 220, and the bucketing system 100 receives data from an entity knowledge base 230. The feature identifier 210 and the formatter 220 may each include hardware, software, or a combination of both. Although the feature identifier 210 and the formatter 220 are illustrated as being distinct components, it will be understand that they may include overlapping hardware, software, or both. Generally, the feature identifier 210 may identify a set of dominant words for each record to be bucketed, based on records in the entity knowledge base 230; and the formatter 220 may structure these dominant words into a table of records for meta-blocking.

The entity knowledge base 230 may include high-quality data, which may include data related to specific entities. Each record 235, also referred to as an entity record, in the entity knowledge base 230 may correspond to an entity referenced to by the entity record 235. In some embodiments, the entity knowledge base 230 is a master data management (MDM) database, a DBpedia database, or a digital bibliography and library project (DBLP) database, for example.

The bucketing system 100 may receive a set of records 245 from one or more data sources 240. These records 245, also referred to as external records 245, may include lower quality data than the entity knowledge base 230. Further, in some embodiments, the data sources 240 are NoSQL data sources. These records 245 may thus be noisy or sparse, or these records 245 may have other issues that make conventional meta-blocking problematic.

Each entity record 235 and each external record 245 includes one or more attributes, or fields. Each attribute has a value, and each value is made up of one or more words, also referred to herein as features. For each external record 245 from the data sources 240, the bucketing system 100 may identify a set of dominant words within that external record 245 based on the entity records 235 in the entity knowledge base 230. More specifically, the bucketing system 100 may identify a set of top k words for each external record 245 of the one or more data sources 240, as discussed further below.

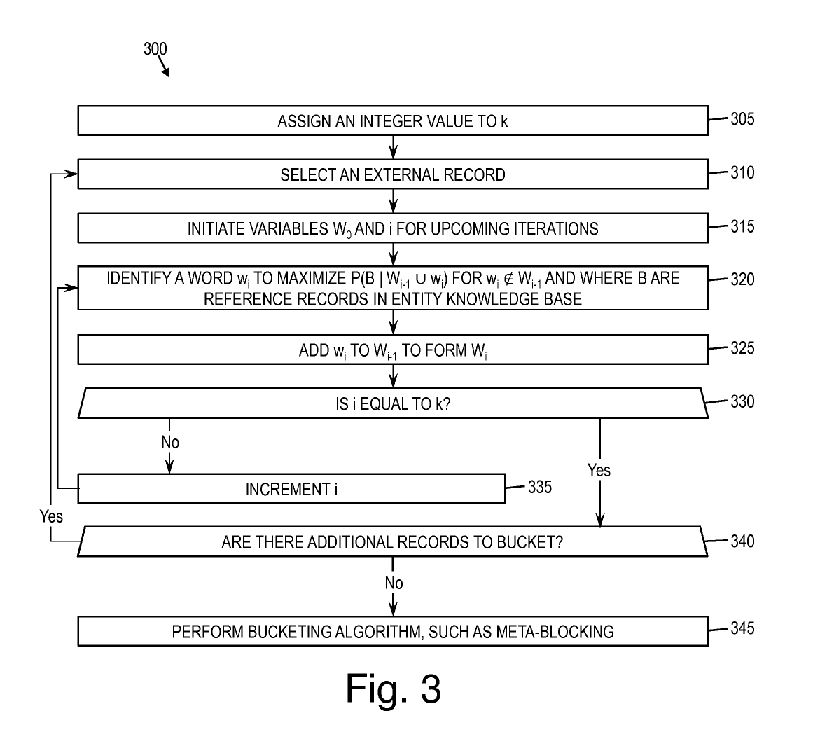

FIG. 3 is flow diagram of a method 300 for bucketing the records 245 from the data sources 240, based on identifying dominant words for each external record 245, according to some embodiments of this disclosure.

At block 305, the variable k may be assigned an integer value. The variable k indicates how many dominant words are selected for reach external record 245. At block 310, an external record 245 received from the data sources 240 may be selected. For this external record 245, the bucketing system 100 identifies k dominant words within the record, according to the following blocks of the method 300. At block 315, some variables used within iterations are initiated. Specifically, a set W₀ may be initially defined as the null set, and a variable i may be initially assigned a value of 1. As described below, the set W₀ may be grown into Wₖ, a set of k non-repeating elements, through k iterations.

At block 320, the bucketing system 100 may identify a word wᵢ, appearing within the current external record 245, that maximizes the value of P(B|Wᵢ₋₁∪wᵢ) where wᵢ is not an element of Wᵢ₋₁. The set B is defined as a set of reference records 235 in the entity knowledge base 230. In some embodiments, B includes all the entity records 235 in the entity knowledge base 230. P(B|W) is defined as the probability that a word in the set W exists in an entity record 235 of B. In other words, P(B|W) is the normalized frequency at which a word in W occurs in the records of B, where no more than a single occurrence is counted within each entity record 235. This probability may be calculated in various ways. In some embodiments, the wᵢ that maximizes P(B|Wᵢ₋₁∪w) is calculated by calculating P(B|Wᵢ₋₁∪w) for each wᵢ not in the set Wᵢ₋₁, and selecting the wᵢ resulting in the maximum value.

It will be understood that the wᵢ that maximizes the probability P(B|Wᵢ₋₁∪w) may differ from the wᵢ that occurs most frequently in the set B, due to the inherent discarding of multiple occurrences within a single entity record 235 in the calculation of P(B|Wᵢ₋₁∪w). For instance if wₓ is the word not in Wᵢ₋₁ that occurs most frequently in B, but wₓ occurs only in entity records 235 of B in which a word of Wᵢ₋₁ already occurs, then P(B|Wᵢ₋₁∪wₓ) is equal to P(B|Wᵢ₋₁); and a word w_{y} that occurs only once in the entity records 235 of B, but in an entity record 235 in which no word of Wᵢ₋₁ occurs, would mean that P(B|Wᵢ₋₁∪w_{y}) is greater than P(B|Wᵢ₋₁). In that case, w_{y} would be selected over wₓ despite the fact that wₓ occurs more frequently.

At block 325, the wᵢ that maximizes this probability P(B|Wᵢ₋₁∪w) may be added to the set Wᵢ₋₁, resulting in the set Wᵢ, with contains i number of words total.

At decision block 330, it may be determined whether the current value of i is equal to k. If not, then the value of i is less than k, and at least one additional dominant word may be identified for the current external record 245. In that case, the value of i may be incremented at block 335, and the method 300 may then return to block 320. Alternatively, if i is equal to k, then the top k dominant words have already been identified for the current external record 245 and Wₖ for the current record is now known. In that case, then at decision block 340, it may be determined whether there are additional records 245 to be bucketed for which the top k dominant words have not yet been identified. If such an external record 245 exists, then the method 300 may return to block 310 to select a new external record 245. Alternatively, if no such external record 245 exists, then the method 300 has finished finding the top k dominant words for each external record 245 being bucketed.

While some embodiments of the bucketing system 100 use the above-described iterations to find the set Wₖ for each external record 245 from the data sources 240, some alternative embodiments may simply use the k words of an external record 245 that occur most frequently in the records 235 of B as the set Wₖ for that external record 245. It will be understood, however, that embodiments using this alternative may not perform as well as those using the above iterations.

At block 345, the bucketing system 100 may perform meta-blocking, or some other bucketing algorithm 260, considering only the top k dominant words for each external record 245. This meta-blocking may result in the records 245 of the data sources 240 being grouped into buckets.

Conventionally, meta-blocking considers every word of a set records. However, in some embodiments, the bucketing system 100 considers only the top k dominant words for each external record 245 when performing meta-blocking. To this end, the bucketing system 100 may perform the meta-blocking on substitute external records 255, or substitute records, rather than on the original external records 245. These substitute records 255 may include, for each original external record 245, only the top k dominant words as attributes. In some embodiments, the bucketing system 100 may generate the substitute records 255 as a new set of records, such as in a table, where each substitute record 245 generated includes as attributes the top k dominant words identified for the corresponding external record 245. Meta-blocking may then be performed on this generated set of substitute records 255 representing the original external records 245. In some other embodiments, however, the bucketing system 100 performs the meta-blocking using an existing structure of the external records 245 and simply ignores or skips words that are not part of the top k dominant words for each original external record 245 in order to simulate the corresponding substitute record 245. Because each substitute record 255 corresponds to an original external record 245, bucketing of these substitute records 255 translates into bucketing of the original external records 245.

It will be understood that, although meta-blocking is referred to herein as the bucketing algorithm 260 used based on the top k dominant words, various other bucketing algorithms 260 could be substituted for meta-blocking. A benefit of meta-blocking over some other algorithms, however, is that it is schema-agnostic, and thus works well where the top k dominant words of various records 245 do not necessarily come from the same attributes.

Because only the top k dominant words are considered for each external record 245, the bucketing system 100 may automatically ignore noisy or superfluous data that existed in the original external records 245 received from the data sources 240. As a result, the meta-blocking may result in more useful buckets of external records 245. Referring back to FIG. 1, in some embodiments, after the bucketing is complete by way of meta-blocking or another bucketing algorithm, entity matching and record merging may be performed as well.

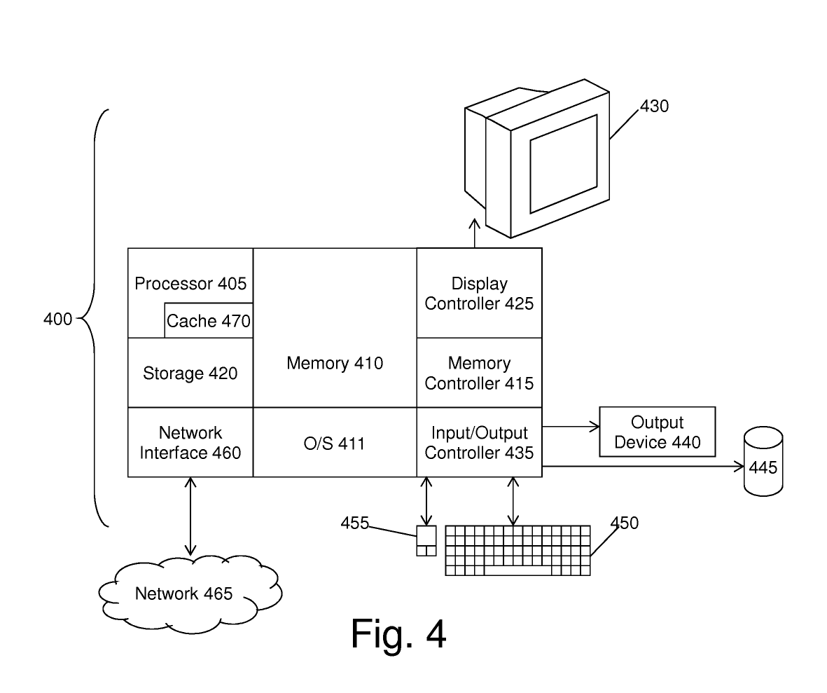

FIG. 4 illustrates a block diagram of a computer system 400 for use in implementing a bucketing system or method according to some embodiments. The bucketing systems and methods described herein may be implemented in hardware, software (e.g., firmware), or a combination thereof. In some embodiments, the methods described may be implemented, at least in part, in hardware and may be part of the microprocessor of a special or general-purpose computer system 400, such as a personal computer, workstation, minicomputer, or mainframe computer.

In some embodiments, as shown in FIG. 4, the computer system 400 includes a processor 405, memory 410 coupled to a memory controller 415, and one or more input devices 445 and/or output devices 440, such as peripherals, that are communicatively coupled via a local I/O controller 435. These devices 440 and 445 may include, for example, a printer, a scanner, a microphone, and the like. Input devices such as a conventional keyboard 450 and mouse 455 may be coupled to the I/O controller 435. The I/O controller 435 may be, for example, one or more buses or other wired or wireless connections, as are known in the art. The I/O controller 435 may have additional elements, which are omitted for simplicity, such as controllers, buffers (caches), drivers, repeaters, and receivers, to enable communications.

The I/O devices 440, 445 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 405 is a hardware device for executing hardware instructions or software, particularly those stored in memory 410. The processor 405 may be a custom made or commercially available processor, a central processing unit (CPU), an auxiliary processor among several processors associated with the computer system 400, a semiconductor based microprocessor (in the form of a microchip or chip set), a macroprocessor, or other device for executing instructions. The processor 405 includes a cache 470, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 470 may be organized as a hierarchy of more cache levels (L1, L2, etc.).

The memory 410 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 410 may incorporate electronic, magnetic, optical, or other types of storage media. Note that the memory 410 may have a distributed architecture, where various components are situated remote from one another but may be accessed by the processor 405.

The instructions in memory 410 may include one or more separate programs, each of which comprises an ordered listing of executable instructions for implementing logical functions. In the example of FIG. 4, the instructions in the memory 410 include a suitable operating system (OS) 411. The operating system 411 essentially may control the execution of other computer programs and provides scheduling, input-output control, file and data management, memory management, and communication control and related services.

Additional data, including, for example, instructions for the processor 405 or other retrievable information, may be stored in storage 420, which may be a storage device such as a hard disk drive or solid state drive. The stored instructions in memory 410 or in storage 420 may include those enabling the processor to execute one or more aspects of the bucketing systems and methods of this disclosure.

The computer system 400 may further include a display controller 425 coupled to a display 430. In some embodiments, the computer system 400 may further include a network interface 460 for coupling to a network 465. The network 465 may be an IP-based network for communication between the computer system 400 and an external server, client and the like via a broadband connection. The network 465 transmits and receives data between the computer system 400 and external systems. In some embodiments, the network 465 may be a managed IP network administered by a service provider. The network 465 may be implemented in a wireless fashion, e.g., using wireless protocols and technologies, such as WiFi, WiMax, etc. The network 465 may also be a packet-switched network such as a local area network, wide area network, metropolitan area network, the Internet, or other similar type of network environment. The network 465 may be a fixed wireless network, a wireless local area network (LAN), a wireless wide area network (WAN) a personal area network (PAN), a virtual private network (VPN), intranet or other suitable network system and may include equipment for receiving and transmitting signals.

Bucketing systems and methods according to this disclosure may be embodied, in whole or in part, in computer program products or in computer systems 400, such as that illustrated in FIG. 4.

Technical effects and benefits of some embodiments include a schema-agnostic mechanism that can improve performance of bucketing as compared to existing bucketing techniques. Through identifying top dominant words for each record, some embodiments may disregard superfluous and noisy data, and may thus provide better bucketing results and, therefore, better entity matching for heterogeneous data.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1-7. (canceled)

8. A system comprising:
a memory; and
one or more computer processors, communicatively coupled to the memory, the one or more computer processors configured to:
receive a plurality of external records from one or more data sources;
determine a plurality of sets of top k dominant words for the plurality of external records, wherein the plurality of sets of top k dominant words comprise a set of top k dominant words for each external record of the plurality of external records, and wherein k is an integer; and
perform a bucketing algorithm on the plurality of external records while excluding from consideration words within each external record that are not within the set of top k dominant words for the external record.

9. The system of claim 8, wherein to determine the plurality of sets of top k dominant words for the plurality of external records, the one or more computer processors are further configured to:
determine k dominant words appearing in a first external record of the plurality of records, based at least in part on a plurality of entity records received from an entity knowledge base.

10. The system of claim 9, wherein to determine the k dominant words within the first external record, the one or more computer processors are further configured to:
establish a set of words from the first external record;
identify which word from the first external record, when added to the set of words, maximizes a probability of the set of words occurring in an entity record of the entity knowledge base; and
repeat the establishing and the identifying until k words are in the set of the words from the first external record.

11. The system of claim 8, wherein to perform the bucketing algorithm on the plurality of external records while excluding from consideration words within each external record that are not within the set of top k dominant words for the external record, the one or more computer processors are further configured to:
substitute a plurality of substitute records for the plurality of external records, wherein each substitute record corresponds to an external record and excludes words from the corresponding external record that are not in the top k dominant words for the corresponding external record; and
perform the bucketing algorithm on the plurality of substitute records to bucket the plurality of external records.

12. The system of claim 8, wherein the plurality of external records have differing schemas, and wherein performing the bucketing algorithm on the plurality of external records while excluding from consideration words within each external record that are not within the set of top k dominant words for the external record is schema-agnostic.

13. The system of claim 8, wherein at least one of the one or more data sources is a Not Only Structured Query Language (NoSQL) data source.

14. The system of claim 8, wherein the bucketing algorithm comprises meta-blocking.

15. A computer program product for bucketing records, the computer program product comprising a computer readable storage medium having program instructions embodied therewith, the program instructions executable by a processor to cause the processor to perform a method comprising:
receiving a plurality of external records from one or more data sources;
determining a plurality of sets of top k dominant words for the plurality of external records, wherein the plurality of sets of top k dominant words comprise a set of top k dominant words for each external record of the plurality of external records, and wherein k is an integer; and
performing a bucketing algorithm on the plurality of external records while excluding from consideration words within each external record that are not within the set of top k dominant words for the external record.

16. The computer program product of claim 15, wherein determining the plurality of sets of top k dominant words for the plurality of external records comprises:
determining k dominant words appearing in a first external record of the plurality of records, based at least in part on a plurality of entity records received from an entity knowledge base.

17. The computer program product of claim 16, wherein determining the k dominant words within the first external record comprises:
establishing a set of words from the first external record;
identifying which word from the first external record, when added to the set of words, maximizes a probability of the set of words occurring in an entity record of the entity knowledge base; and
repeating the establishing and the identifying until k words are in the set of the words from the first external record.

18. The computer program product of claim 15, wherein performing the bucketing algorithm on the plurality of external records while excluding from consideration words within each external record that are not within the set of top k dominant words for the external record comprises:
substituting a plurality of substitute records for the plurality of external records, wherein each substitute record corresponds to an external record and excludes words from the corresponding external record that are not in the top k dominant words for the corresponding external record; and
performing the bucketing algorithm on the plurality of substitute records to bucket the plurality of external records.

19. The computer program product of claim 15, wherein the plurality of external records have differing schemas, and wherein performing the bucketing algorithm on the plurality of external records while excluding from consideration words within each external record that are not within the set of top k dominant words for the external record is schema-agnostic.

20. The computer program product of claim 15, wherein at least one of the one or more data sources is a Not Only Structured Query Language (NoSQL) data source.
